(19) United States
(12) Patent Application Publication
(10) Pub. No.: US 2016/0370679 A1
(43) Pub. Date: Dec. 22, 2016

(54) ELECTROCHROMIC GRATING, MANUFACTURING METHOD THEREOF, DISPLAY PANEL AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Changfeng LI, Beijing (CN); Xue Dong, Beijing (CN); Haisheng Wang, Beijing (CN); Hailin Xue, Beijing (CN); Yingming Liu, Beijing (CN); Shengji Yang, Beijing (CN); Weiqing Zhao, Beijing (CN); Mubing LI, Beijing (CN)

(21) Appl. No.: 14/906,484

(22) PCT Filed: Aug. 12, 2015
(86) PCT No.: PCT/CN2015/086769

§ 371 Date: Jan. 20, 2016

(30) Foreign Application Priority Data
Feb. 6, 2015 (CN) 201510065142.0

(51) Int. Cl. G02F 1/155; G02F 1/157; G02B 27/22; G02F 1/1343

(52) U.S. Cl. CPC G02F 1/155; G02F 1/13439; G02F 1/157; G02B 27/2214; G02F 2201/30

(57) ABSTRACT

The embodiments of the present invention disclose an electrochromic grating, a manufacturing method thereof, a display panel and a display device. The method of manufacturing the electrochromic grating comprises: forming a first transparent electrode layer on a first substrate; forming a resin layer on the first transparent electrode layer and forming a plurality of grooves in the resin layer; forming a second transparent electrode layer on a second substrate; perfusing at least one of solution type or gel type electrochromic material into the plurality of grooves; and then, encapsulating the first substrate and the second substrate. In this way, by using the at least one of solution type or gel type electrochromic material filled in the grooves, the conversion speed of the electrochromic grating between the transparent state and the colored state can be increased, the conversion response speed of the display panel between 2D picture and 3D picture can be further increased, so as to realize a higher contrast, thereby improving the display effect.

### FIELD OF THE INVENTION

The present invention relates to the field of display technology, particularly to an electrochromic grating, a manufacturing method thereof, a display panel and a display device.

### BACKGROUND OF THE INVENTION

The 3D display has become a trend in the field of display owing to its verisimilitude, and is gradually becoming part of people's life. At present, the 3D technology can be classified into naked-eye type and glasses type. The glasses type 3D technology requires wearing special glasses, which is inconvenient for carry; hence, the tablet computer and mobile phone products pay more attention to the naked-eye 3D technology. The current naked-eye 3D technology mainly comprises two modes: grating mode and cylindrical lens mode. The cylindrical lens mode is generally incompatible with the liquid crystal display panel or the organic electroluminescent display panel, so the panel manufacturer focuses more on utilizing the grating mode to realize naked-eye 3D technology.

The grating mode limits the light with particular angles by whole columns of opaque material, so that the left eye can only see the image that needs to be seen by the left eye, the right eye can only see the image that needs to be seen by the right eye, thereby generating a stereoscopic image. Therefore, the category of the electrochromic material determines the conversion speed of the electrochromic grating between the transparent state and the colored state, i.e., it determines the conversion response speed of the display panel between 2D picture and 3D picture. At present, the electrochromic grating utilizes solid state electrochromic material to achieve the grating effect, whereas the conversion speed of the solid state electrochromic material between the transparent state and the colored state is relatively slow, such that the conversion response speed of the display panel between the 2D picture and the 3D picture is relatively slow, and the contrast is relatively low.

Therefore, how to utilize an electrochromic material of other state to increase the conversion speed of the electrochromic grating between the transparent state and the colored state, so as to further improve the display effect is a technical problem that needs to be solved by the skilled person in the art urgently.

### SUMMARY OF THE INVENTION

In view of this, the embodiments of the present invention provide an electrochromic grating, a manufacturing method thereof, a display panel and a display device, which can increase the conversion speed of the electrochromic grating between the transparent state and the colored state, thereby improving the display effect.

Therefore, an embodiment of the present invention provides a method of manufacturing an electrochromic grating, comprising:

forming a first transparent electrode layer on a first substrate;

forming a resin layer on the first transparent electrode layer and forming a plurality of grooves in the resin layer;

forming a second transparent electrode layer on a second substrate;

perfusing at least one of solution type or gel type electrochromic material into the plurality of grooves;

encapsulating the first substrate and the second substrate.

The solution type or the gel type electrochromic material has the characteristic of high response speed and can realize conversion between the transparent state and the colored state quickly because the ions or electrons thereof have strong movement ability and high migration speed. Thus, the conversion speed of the electrochromic grating between the transparent state and the colored state can be increased, thereby improving the display effect.

In a possible implementation, in the method of manufacturing an electrochromic grating provided by the embodiment of the present invention, the first transparent electrode layer and the second transparent electrode layer have strip patterns, a same mask plate is used to form patterns of the first transparent electrode layer and the second transparent electrode layer.

In a possible implementation, in the method of manufacturing an electrochromic grating provided by the embodiment of the present invention, forming a resin layer on the first transparent layer and forming a plurality of grooves in the resin layer comprise:

depositing a layer of transparent resin material on the first transparent electrode layer;

performing patterning process to the resin material, so as to form patterns of the grooves at positions of the resin material corresponding to the strip patterns of the first transparent electrode layer.

In a possible implementation, in the method of manufacturing an electrochromic grating provided by the embodiment of the present invention, the resin material is poly methyl methacrylate or polyethylene glycol terephthalate.

In a possible implementation, in the method of manufacturing an electrochromic grating provided by the embodiment of the present invention, after forming the first transparent electrode layer on the first substrate, and before forming a resin layer on the first transparent electrode layer and forming a plurality of grooves in the resin layer, it further comprises: forming a first electrode protective layer on the first substrate on which the first transparent electrode layer is formed.

In a possible implementation, in the method of manufacturing an electrochromic grating provided by the embodiment of the present invention, the first electrode protective layer has strip patterns, a same mask plate is used to form patterns of the first electrode protective layer and the first transparent electrode layer.

In a possible implementation, in the method of manufacturing an electrochromic grating provided by the embodiment of the present invention, after forming the second transparent electrode layer on the second substrate, it further comprises: forming a second electrode protective layer on the second substrate on which the second transparent electrode layer is formed.

In a possible implementation, in the method of manufacturing an electrochromic grating provided by the embodiment of the present invention, the second electrode protective layer has strip patterns, a same mask plate is used to form patterns of the second electrode protective layer and the second transparent electrode layer.

In a possible implementation, in the method of manufacturing an electrochromic grating provided by the embodiment of the present invention, a base substrate of an upper substrate in a display panel is used as the first substrate, a polarizer is used as the second substrate; or,

the base substrate of the upper substrate in the display panel is used as the second substrate, the polarizer is used as the first substrate.

An embodiment of the present invention further provides an electrochromic grating manufactured using the method provided by the embodiment of the present invention, the electrochromic grating comprises: a first substrate and a second substrate arranged oppositely, a first transparent electrode layer arranged on a surface of the first substrate facing the second substrate, a second transparent electrode layer arranged on a surface of the second substrate facing the first substrate, a resin layer arranged between the first substrate and the second substrate, a plurality of grooves formed in the resin layer, and at least one of solution type or gel type electrochromic material filled in the plurality of grooves.

The embodiment of the present invention further provides a display panel comprising the above electrochromic grating provided by the embodiment of the present invention.

In a possible implementation, in the above display panel provided by the embodiment of the present invention, a preset angle is between an extending direction of respective grooves in the resin layer in the electrochromic grating and a row direction of respective pixels in the display panel.

The embodiment of the present invention further provides a display device comprising the above display panel provided by the embodiment of the present invention.

The beneficial effect of the embodiment of the present invention comprises:

The embodiment of the present invention provides an electrochromic grating, a manufacturing method thereof, a display panel and a display device, the method comprising: forming a first transparent electrode layer on a first substrate; forming a resin layer on the first transparent electrode layer and forming a plurality of grooves in the resin layer; forming a second transparent electrode layer on a second substrate; perfusing at least one of solution type or gel type electrochromic material into the plurality of grooves; and then, encapsulating the first substrate and the second substrate. In this way, by using the at least one of solution type or gel type electrochromic material filled in the grooves, the conversion speed of the electrochromic grating between the transparent state and the colored state can be increased, the conversion response speed of the display panel between 2D picture and 3D picture can be further increased, so as to realize a higher contrast, thereby improving the display effect.

### BRIEF DESCRIPTION OF THE DRAWINGS

FIG. 1 is a flow chart of a method of manufacturing an electrochromic grating provided by an embodiment of the present invention;

FIG. 2 is a flow chart of a method of manufacturing an electrochromic grating provided by another embodiment of the present invention;

FIG. 3a to FIG. 3f are respectively structural schematic diagrams after performing respective steps of the method of manufacturing an electrochromic grating provided by the embodiment of the present invention;

FIG. 4a to FIG. 4c are respectively structural schematic diagrams of the electrochromic grating provided by the embodiment of the present invention;

FIG. 5a and FIG. 5b are respectively structural schematic diagrams of occlusion of respective pixels by the electrochromic grating in a display panel provided by the embodiment of the present invention.

### DETAILED DESCRIPTION OF THE INVENTION

The solution type or the gel type electrochromic material has the characteristic of high response speed, and can realize conversion between the transparent state and the colored state quickly because the ions or electrons thereof have strong movement ability and high migration speed.

The method of manufacturing an electrochromic grating provided by the embodiment of the present invention exactly use at least one of the solution type or the gel type electrochromic material as a part of the electrochromic grating to increase the conversion speed of the electrochromic grating between the transparent state and the colored state, so as to realize a high contrast and improve the display effect.

The specific implementations of the electrochromic grating, the manufacturing method thereof, the display panel and the display device provided by the embodiments of the present invention will be explained in detail below with reference to the drawings.

Wherein the thickness and the shape of the film layers in the drawings do not reflect the real proportion of the electrochromic grating, which only aim to explain the contents of the present invention schematically.

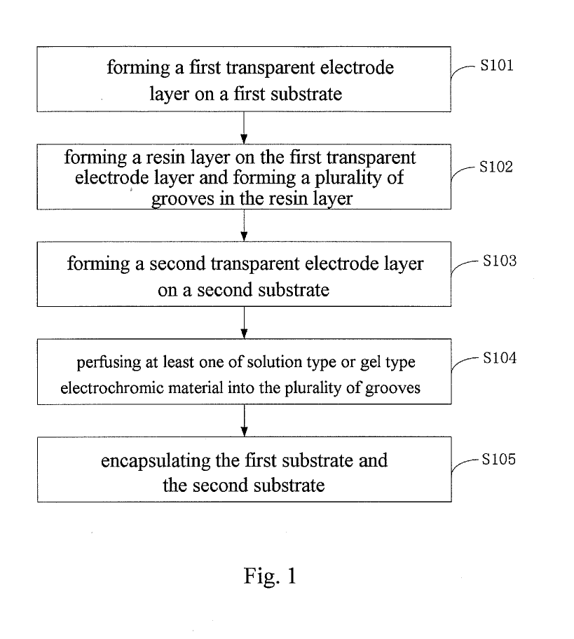

An embodiment of the present invention provides a method of manufacturing an electrochromic grating, as shown in FIG. 1, comprising the steps of:

S101, forming a first transparent electrode layer on a first substrate;

S102, forming a resin layer on the first transparent electrode layer and forming a plurality of grooves in the resin layer;

S103, forming a second transparent electrode layer on a second substrate;

S104, perfusing at least one of solution type or gel type electrochromic material into the plurality of grooves;

S105, encapsulating the first substrate and the second substrate.

In a specific implementation, it needs to be noted that the steps S101-S102 and the step S103 can be performed in any order, i.e.: the step S103 can also be performed firstly, then the step S101 and the step S102 are performed; also, the steps S101-S102 and the step S103 can be performed simultaneously, which will not be limited here.

In the above method of manufacturing an electrochromic grating provided by the embodiment of the present invention, since the category of the electrochromic material determines the conversion speed of the electrochromic grating between the transparent state and the colored state, and the solution type or the gel type electrochromic material has the characteristic of high response speed because the ions or electrons thereof have strong movement ability and high migration speed; therefore, manufacture the electrochromic grating by filling at least one solution type or gel type electrochromic material in the grooves can increase the conversion speed of the electrochromic grating between the transparent state and the colored state, and can further increase the conversion response speed of the display panel between the 2D picture and the 3D picture, so as to realize a higher contrast, thereby improving the display effect.

In a specific implementation, in the above method of manufacturing an electrochromic grating provided by the embodiment of the present invention, the first transparent electrode layer and the second transparent electrode layer can be arranged as a continuous layer respectively, and can also be arranged as strips according to the area where the electrochromic material locates, which will not be limited here. When the first transparent electrode layer and the second transparent electrode layer are both arranged as strips, a same mask plate can be used to form the patterns of the first transparent electrode layer and the second transparent electrode layer, thus the manufacturing process can be simplified.

In a specific implementation, in the above method of manufacturing an electrochromic grating provided by the embodiment of the present invention, the step S102 of forming a resin layer on the first transparent layer and forming a plurality of grooves in the resin layer may specifically comprise:

firstly, depositing a layer of transparent resin material on the first transparent electrode layer;

then, performing patterning process to the resin material, so as to form patterns of the grooves at positions of the resin material corresponding to the strip patterns of the first transparent electrode layer.

It needs to be noted that in order to prevent color mixing, the width of each groove pattern should be less than or equal to the width of the strip pattern of the first transparent electrode layer.

In a specific implementation, in the above method of manufacturing an electrochromic grating provided by the embodiment of the present invention, the resin material generally can be poly methyl methacrylate (PMMA) or polyethylene glycol terephthalate (PET), and can also be other transparent and insulating resin materials, which will not be limited here.

In a specific implementation, in the above method of manufacturing an electrochromic grating provided by the embodiment of the present invention, generally, after the step S101 of forming a first transparent electrode layer on a first substrate is performed, and before the step S102 of forming a resin layer on the first transparent electrode layer and forming a plurality of grooves in the resin layer is performed, it may further comprise: forming a first electrode protective layer on the first substrate on which the first transparent electrode layer is formed, for protecting the first transparent electrode layer.

In a specific implementation, in the above method of manufacturing an electrochromic grating provided by the embodiment of the present invention, the first electrode protective layer can be as a continuous layer, and can also be arranged as strips. When the first electrode protective layer is arranged as strips, a same mask plate can be used to form the patterns of the first electrode protective layer and the first transparent electrode layer, thus the manufacturing process can be simplified, and the manufacturing cost can be reduced.

In a specific implementation, in the above method of manufacturing an electrochromic grating provided by the embodiment of the present invention, generally after the step S103 of forming a second transparent electrode layer on a second substrate is performed, it may further comprise: forming a second electrode protective layer on the second substrate on which the second transparent electrode layer is formed, for protecting the second transparent electrode layer.

In a specific implementation, in the above method of manufacturing an electrochromic grating provided by the embodiment of the present invention, the second electrode protective layer can be as a continuous layer, and can also be arranged as strips. When the second electrode protective layer is arranged as strips, a same mask plate can be used to form the patterns of the second electrode protective layer and the second transparent electrode layer, thus the manufacturing process can be simplified, and the manufacturing cost can be reduced.

In a specific implementation, in the above method of manufacturing an electrochromic grating provided by the embodiment of the present invention, specifically, in a first implementation, a base substrate of an upper substrate in a display panel can be used as the first substrate, a polarizer can be used as the second substrate; or,

specifically, in a second implementation, the base substrate of the upper substrate in the display panel can be used as the second substrate, the polarizer can be used as the first substrate.

In the above two implementations, only the objects represented by the first substrate and the second substrate are changed, both directly use the polarizer to replace the upper substrate of the existing electrochromic grating, thus the thickness of the display panel can be further reduced effectively. In a specific implementation, it can be designed based on actual needs, which will not be limited here.

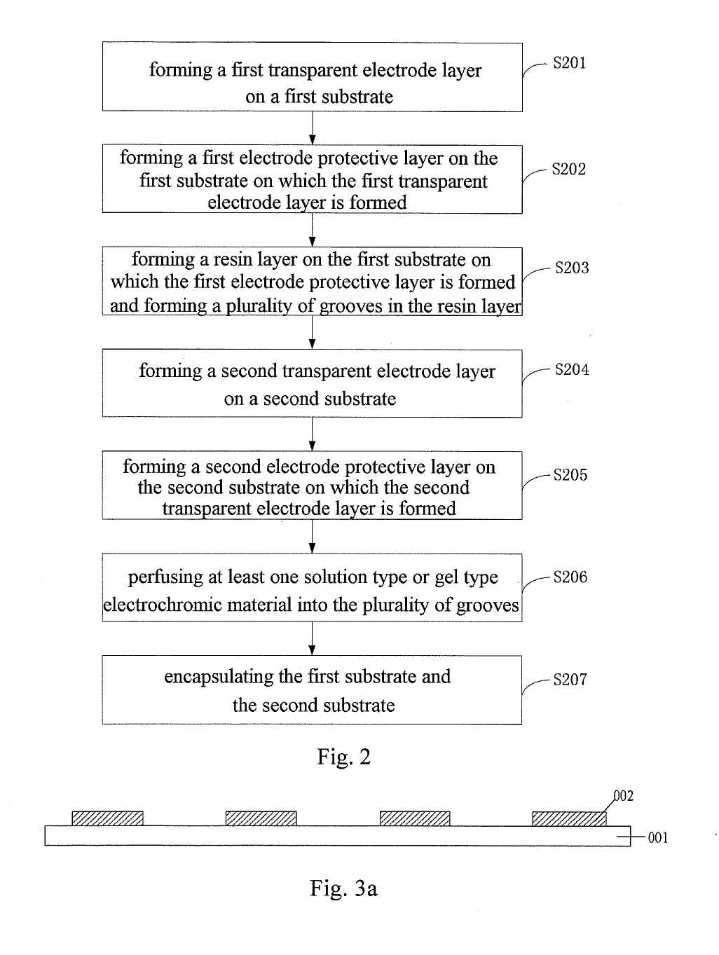

There are various implementations to carry out the method of manufacturing the electrochromic grating provided by the embodiment of the present invention specifically; in the following, the method of manufacturing the electrochromic grating provided by the embodiment of the present invention will be explained in detail with an example, as shown in FIG. 2, the method may comprise the steps of:

S201, forming a first transparent electrode layer on a first substrate;

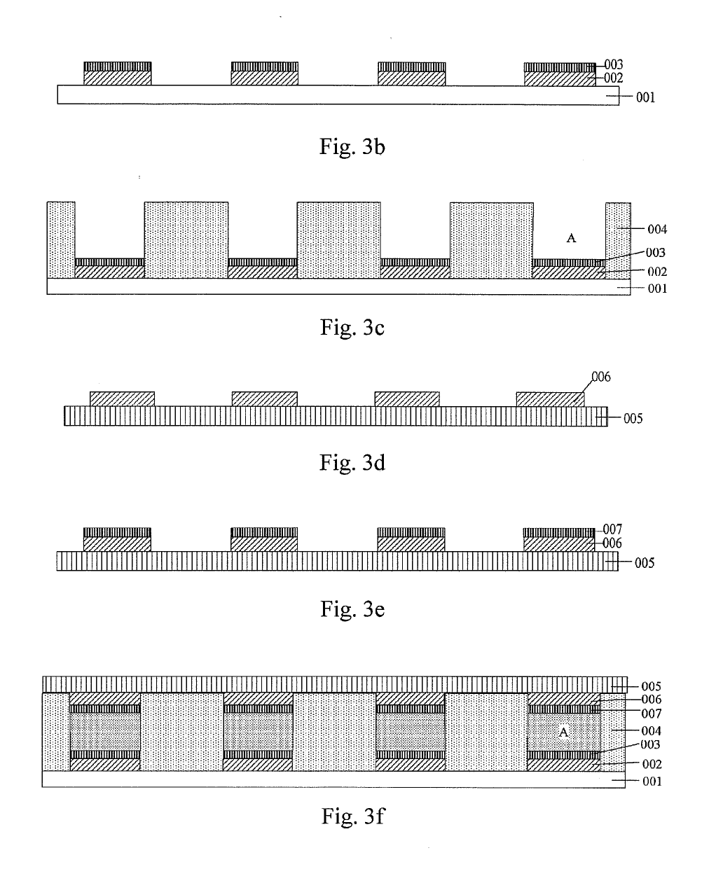

In a specific implementation, as shown in FIG. 3a, a first transparent electrode layer 002 is formed on a base substrate 001 of an upper substrate in a display panel, here the first transparent electrode layer has strip patterns; the first transparent electrode layer can also be formed on a polarizer, the first transparent electrode layer can also be arranged as a continuous layer, which will not be limited here;

S202, forming a first electrode protective layer on the first substrate on which the first transparent electrode layer is formed;

In a specific implementation, as shown in FIG. 3b, a first electrode protective layer 003 is formed on the base substrate 001 on which the first transparent electrode layer 002 is formed, here the first electrode protective layer 003 can have the same strip patterns as the first transparent electrode layer 002, and can also have the same continuous layer structure as the first transparent electrode layer 002, which will not be limited here;

S203, forming a resin layer on the first substrate on which the first electrode protective layer is formed and forming a plurality of grooves in the resin layer;

In a specific implementation, firstly, a layer of transparent resin layer 004 material is deposited on the first electrode protective layer 003; then, patterning process is performed to the resin layer 004, the patterns of grooves A are formed at positions of the resin layer 004 corresponding to the strip patterns of the first transparent electrode layer 002, as shown in FIG. 3c;

S204, forming a second transparent electrode layer on a second substrate;

In a specific implementation, as shown in FIG. 3d, a second transparent electrode layer 006 is formed on a polarizer 005, here the second transparent electrode layer 006 has strip patterns; similarly, the second transparent electrode layer can also be formed on the base substrate of the upper substrate in the display panel, the second transparent electrode layer can also be arranged as a continuous layer, which will not be limited here;

S205, forming a second electrode protective layer on the second substrate on which the second transparent electrode layer is formed;

In a specific implementation, as shown in FIG. 3e, a second electrode protective layer 007 is formed on the polarizer 005 on which the second transparent electrode layer 006 is formed, here the second electrode protective layer 007 can have the same strip patterns as the second transparent electrode layer 006, and can also be a continuous layer, which will not be limited here;

S206, perfusing at least one solution type or gel type electrochromic material into the plurality of grooves;

In a specific implementation, at least one solution type or gel type electrochromic material is perfused into the a plurality of grooves A of the resin layer 004;

S207, encapsulating the first substrate and the second substrate;

In a specific implementation, as shown in FIG. 3f, the base substrate 001 and the polarizer 005 are encapsulated to form an electrochromic grating.

Thus, the above electrochromic grating provided by the embodiment of the present invention is manufactured with the above steps S201 to S207 provided by the specific example.

Based on the same inventive concept, the embodiment of the present invention further provides an electrochromic grating manufactured using the above method provided by the embodiment of the present invention. Since the principle of the electrochromic grating for solving problems is similar as the preceding method of manufacturing an electrochromic grating, the implementation of the electrochromic grating can make reference to the implementation of the method of manufacturing the electrochromic grating, which will not be repeated here.

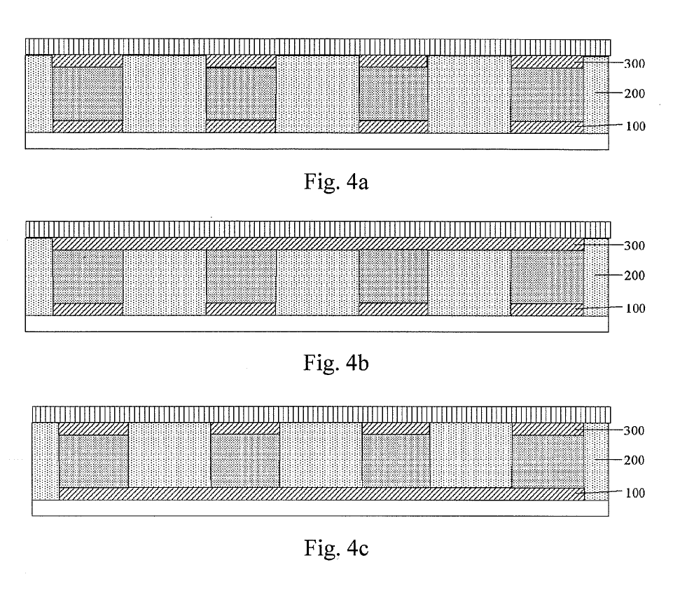

In a specific implementation, the electrochromic grating provided by the embodiment of the present invention, as shown in FIGS. 4a and 4c, may comprise: a first substrate and a second substrate arranged oppositely, a first transparent electrode layer 100 arranged on a surface of the first substrate facing the second substrate, a second transparent electrode layer 300 arranged on a surface of the second substrate facing the first substrate, a resin layer 200 arranged between the first substrate and the second substrate, a plurality of grooves formed in the resin layer 200, and at least one of solution type or gel type electrochromic material filled in the plurality of grooves. As shown in FIG. 4a, the first transparent electrode layer 100 and the second transparent electrode layer 300 have strip patterns; as shown in FIG. 4b, the first transparent electrode layer 100 has strip patterns, the second transparent electrode layer 300 is a continuous layer; as shown in FIG. 4c, the first transparent electrode layer 100 is a continuous layer, the second transparent electrode layer 300 has strip patterns, they can also be other structure, which will not be limited here.

Based on the same inventive concept, the embodiment of the present invention further provides a display panel comprising the above electrochromic grating provided by the embodiment of the present invention. The display panel may be: a liquid crystal display panel, an organic electroluminescent display panel, etc.

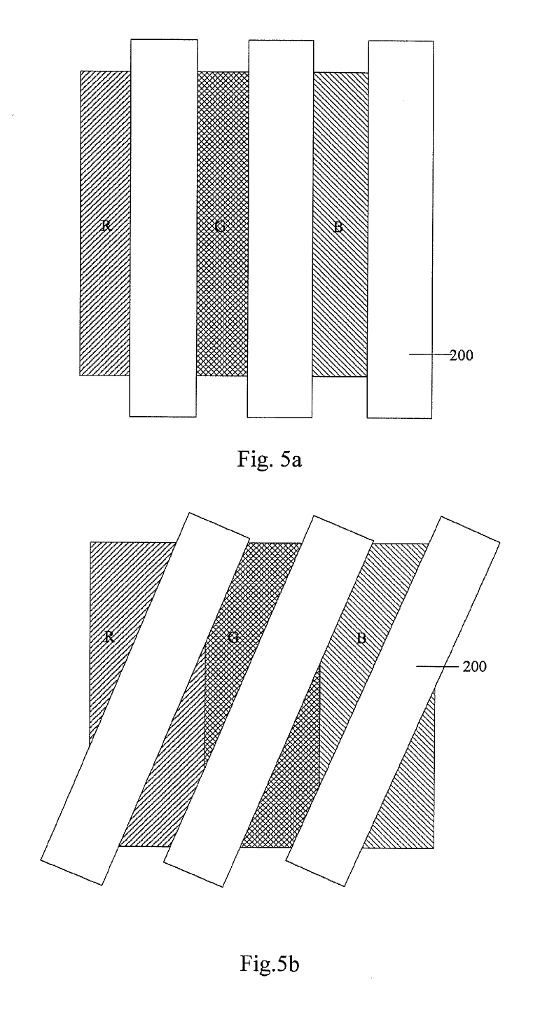

In a specific implementation, in the display panel provided by the embodiment of the present invention, a preset angle is between an extending direction of respective grooves in the resin layer in the electrochromic grating and a row direction of respective pixels in the display panel, i.e., the electrochromic grating may occlude the respective pixels in the display panel at various angles; specifically, as shown in FIG. 5a, the extending direction of respective grooves of the resin layer 200 in the electrochromic grating may be same as the row direction of respective pixels in the display panel; or, as shown in FIG. 5b, the extending direction of respective grooves of the resin layer 200 in the electrochromic grating may be same as the diagonal direction of the respective sub-pixels in the display panel, which will not be limited here.

In a specific implementation, the display panel provided by the embodiment of the present invention may also have other film layer structures generally, and structures such as thin film transistors, gate lines, data lines are also formed on the base substrate generally, these specific structures may have various implementations, which will not be limited here.

Based on the same inventive concept, the embodiment of the present invention further provides a display device comprising the above display panel provided by the embodiment of the present invention, the display device may be any product or component with the display function such as: a mobile phone, a tablet computer, a television, a display, a laptop, a digital photo frame, a navigator, etc. Other essential components of the display device should all be possessed as understood by the ordinary skilled person in the art, which will not be repeated here, and should not be taken as limitations to the present invention either. The implementation of the display device can make reference to the embodiments of the above electrochromic grating, which will not be repeated here.

The embodiment of the present invention provides an electrochromic grating, a manufacturing method thereof, a display panel and a display device, the method comprising: forming a first transparent electrode layer on a first substrate; forming a resin layer on the first transparent electrode layer and forming a plurality of grooves in the resin layer; forming a second transparent electrode layer on a second substrate; perfusing at least one of solution type or gel type electrochromic material into the plurality of grooves; and then, encapsulating the first substrate and the second substrate. In this way, by using the at least one of solution type or gel type electrochromic material filled in the grooves, the conversion speed of the electrochromic grating between the transparent state and the colored state can be increased, the conversion response speed of the display panel between 2D picture and 3D picture can be further increased, so as to realize a higher contrast, thereby improving the display effect.

Apparently, the person skilled in the art may make various alterations and variations to the invention without departing the spirit and scope of the invention. As such, provided that these modifications and variations of the invention pertain to the scope of the claims of the invention and their equivalents, the invention is intended to embrace these alterations and variations.

1-13. (canceled)

14. A method of manufacturing an electrochromic grating, comprising:
forming a first transparent electrode layer on a first substrate;
forming a resin layer on the first transparent electrode layer and forming a plurality of grooves in the resin layer;
forming a second transparent electrode layer on a second substrate;
perfusing at least one of a solution type or a gel type electrochromic material into the plurality of grooves;
encapsulating the first substrate and the second substrate.

15. The method as claimed in claim 14, wherein the first transparent electrode layer and the second transparent electrode layer have strip patterns, and a same mask plate is used to form patterns of the first transparent electrode layer and the second transparent electrode layer.

16. The method as claimed in claim 15, wherein forming a resin layer on the first transparent layer and forming a plurality of grooves in the resin layer comprise:
depositing a layer of transparent resin material on the first transparent electrode layer;
performing patterning process to the resin material, so as to form patterns of the grooves at positions of the resin material corresponding to the strip patterns of the first transparent electrode layer.

17. The method as claimed in claim 16, wherein the resin material is poly methyl methacrylate or polyethylene glycol terephthalate.

18. The method as claimed in claim 14, wherein after forming the first transparent electrode layer on the first substrate, and before forming a resin layer on the first transparent electrode layer and forming a plurality of grooves in the resin layer, further comprising: forming a first electrode protective layer on the first substrate on which the first transparent electrode layer is formed.

19. The method as claimed in claim 15, wherein after forming the first transparent electrode layer on the first substrate, and before forming a resin layer on the first transparent electrode layer and forming a plurality of grooves in the resin layer, further comprising: forming a first electrode protective layer on the first substrate on which the first transparent electrode layer is formed.

20. The method as claimed in claim 18, wherein the first electrode protective layer has strip patterns, a same mask plate is used to form patterns of the first electrode protective layer and the first transparent electrode layer.

21. The method as claimed in claim 19, wherein the first electrode protective layer has strip patterns, a same mask plate is used to form patterns of the first electrode protective layer and the first transparent electrode layer.

22. The method as claimed in claim 14, wherein after forming the second transparent electrode layer on the second substrate, further comprising: forming a second electrode protective layer on the second substrate on which the second transparent electrode layer is formed.

23. The method as claimed in claim 15, wherein after forming the second transparent electrode layer on the second substrate, further comprising: forming a second electrode protective layer on the second substrate on which the second transparent electrode layer is formed.

24. The method as claimed in claim 22, wherein the second electrode protective layer has strip patterns, a same mask plate is used to form patterns of the second electrode protective layer and the second transparent electrode layer.

25. The method as claimed in claim 23, wherein the second electrode protective layer has strip patterns, a same mask plate is used to form patterns of the second electrode protective layer and the second transparent electrode layer.

26. The method as claimed in claim 14, wherein a base substrate of an upper substrate in a display panel is used as the first substrate, a polarizer is used as the second substrate; or, the base substrate of the upper substrate in the display panel is used as the second substrate, the polarizer is used as the first substrate.

27. An electrochromic grating manufactured using the method as claimed in claim 41, wherein the electrochromic grating comprises: a first substrate and a second substrate arranged oppositely, a first transparent electrode layer arranged on a surface of the first substrate facing the second substrate, a second transparent electrode layer arranged on a surface of the second substrate facing the first substrate, a resin layer arranged between the first substrate and the second substrate, a plurality of grooves formed in the resin layer, and at least one of solution type or gel type electrochromic material filled in the plurality of grooves.

28. A display panel, wherein comprising an electrochromic grating as claimed in claim 27.

29. The display panel as claimed in claim 28, wherein a preset angle is between an extending direction of respective grooves in the resin layer in the electrochromic grating and a row direction of respective pixels in the display panel.

30. A display device, wherein, comprising a display panel as claimed in claim 28.

31. The display device as claimed in claim 30, wherein a preset angle is between an extending direction of respective grooves in the resin layer in the electrochromic grating and a row direction of respective pixels in the display panel.
